(19) United States
(12) Patent Application Publication
(10) Pub. No.: US 2017/0266742 A1
(43) Pub. Date: Sep. 21, 2017

(54) Chainsaw Push Vise

(71) Applicant: Edward Joseph Hetrick, SR., East Freedom, PA (US)

(72) Inventor: Edward Joseph Hetrick, SR., East Freedom, PA (US)

(21) Appl. No.: 15/072,566

(22) Filed: Mar. 17, 2016

(51) Int. Cl. B23D 63/00; B25B 1/24; B23D 63/16; B25B 1/20

(52) U.S. Cl. CPC B23D 63/003; B25B 1/20; B25B 1/2484; B23D 63/168

(57) ABSTRACT

A vise for securing a chainsaw in a fixed position for field repairs and resharpening the cutting elements on the chain of a chainsaw. The vise is one piece body of generally rectangular shape with two upwardly projecting legs spaced wide enough to accept a chainsaw bar with one leg having a threaded hole and the opposing leg has a raised area. Protruding from the body downward is a tapered tang with serrated/ridges in the tapered side tang, the vise is then pushed into a piece of wood that has a slot cut into it with a chainsaw. the push vise provides a versatile device not limiting the user to just one surface, is safe to carry on your person and is easily and quickly anchored and removed.

### FIELD OF INVENTION

The present invention is designed to be easily and quickly anchored into a piece of wood to hold a chainsaw in a fixed and sturdy position for servicing such as filing (resharpening) or field repairs.

### BACKGROUND OF THE INVENTION

Any person familiar with operating a chainsaw and if said person has a understanding of filing the chainsaw cutting implements is aware of the problem of keeping the saw in one position, this is usually accomplished by the person holding the saw with one hand and filing with the other hand. There are vises already made that secure the saw in a fixed position with a clamping mechanism to hold the chainsaw bar and various anchoring ways.

one known device has several spikes that are driven into a stump for anchoring. Another known device has generally the same clamping mechanism and a protruding screw that is turned into a piece of wood to anchor it. Both vises have been generally adequate for there intended purposes but not satisfactory in all areas. The vise with spikes must be driven into a stump with a hammer, it is possible that repeated blows to the top of the vise eventually will break the vise, if you miss and hit the side of the vise that has the screw it can cause the screw to bend or break off rendering the vise useless until repaired or replaced. The vise with the downward protruding screw is not safe to carry on your person and depending on what type of wood you are trying to anchor the vise into you may need to drill a pilot hole first to get it started.

The chain saw push vise is designed to be safely carried on your person, with no spikes or exposed screws, it is quickly anchored and removed from a piece of wood. The push vise is pushed into a piece of wood that has a slot cut into it by a chainsaw. the tapered tang with serrations/ridges is then pushed into the cut kerf with enough force to secure the vise firmly into the piece of wood, The ridges or serrations on the tapered side of the tang are designed that the pressure of the resisting wood fills the serration valleys and furthermore holds the vise in a secure position. The push vise has a general clamping mechanism stated in prior vises.

The push vise is lightweight, compact and fits easily into a pocket, it needs no tools to use and can be used on stumps, logs and billets of wood that have the bark on or off and on flat, uneven and contoured surfaces. The improvement over prior chainsaw vises is that the push vise is safe to carry on your person, is easily and quickly installed and removed because of its tapered tang.

another object of the push vise is to secure a chainsaw in a fixed position for field repairs and sharpening.

Another object of the push vise is to give the user a simple, quick and easy way to secure a chainsaw.

Another objective of the push vise is to give the user the ability to have both hands on the file when sharpening the cutter teeth.

### SUMMARY OF THE INVENTION

It is the object of the invention, including what is stated within, to clamp a chainsaw bar securely and to be anchored into a piece of wood by its tapered tang that is pushed into the cut kerf for securing the chainsaw in a fixed position.

### BRIEF DESCRIPTION OF DRAWING

FIG. 1 is a side view

FIG. 2 is an edge view

FIG. 3 is a top view

### DETAILED DESCRIPTION OF THE DRAWINGS

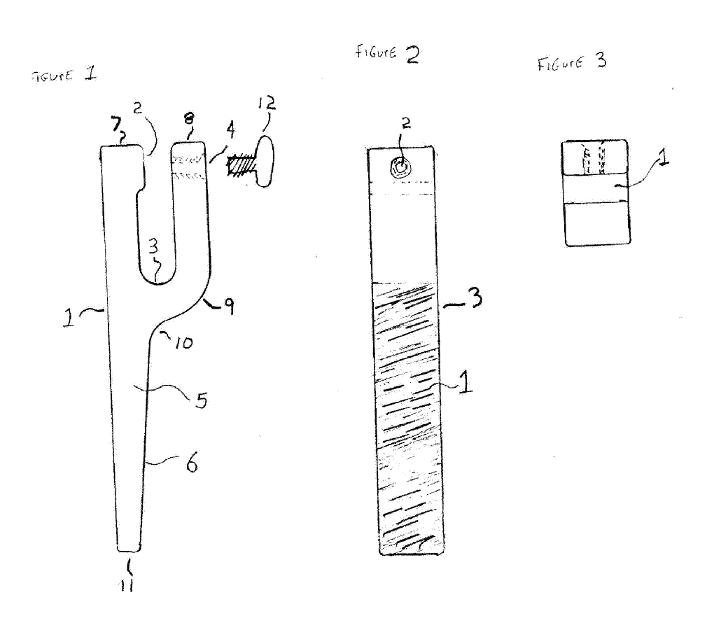

FIG. 1-3 show a chainsaw push vise that embodies the present invention.

FIG. 1 shows the side view of the push vise 5, 1 shows a flat side of the vise and going up to surface 7 and then to surface 2 as a standoff/raised area and that follows a profile to the bottom of the slot into a radius 3 which then goes back up to the top 8 then transfers parallel 4 to side 1 at less than half the distance of the overall length which begins into a radius 9 and continuous into a opposite radius 10 which is the start of the tapered tang 6 which runs at a inward angle to side 1 until it reaches 11 flat at the very bottom.

FIG. 2 shows a rectangle profile 3 with 2 is a tapped hole for a thumb screw that clamps the chainsaw bar, surface 1 is the tapered side of the tang and depicts ridges/serrations

FIG. 3 shows a top view and the 1 opening that is wide enough to accept various sizes of chainsaw bars and chains.

1. A chainsaw push vise, compromising:
a) The invention of claim 1 further compromising of a body having two spaced apart legs projecting in the same direction upwardly from the body, A threaded screw at a 90 degree angle off of one upwardly leg, A raised standoff on the opposing upwardly leg directly opposite the threaded screw and a tapered shank protruding downward from the body:
b) the invention of claim 1 further compromising of a tapered tang protruding downward from the body:
c) The invention of claim 1 further compromising of serrations/ridges cut into the tapered side of the tang:

3. A clamping means to hold a chainsaw bar, compromising:
a) The invention of claim 3 further compromising of a u shaped opening with two fixed jaws:
b) The invention of claim 3 further compromising of a raised area directly across from the threaded hole:
